(19) United States
(12) Patent Application Publication
(10) Pub. No.: US 2012/0015245 A1
(43) Pub. Date: Jan. 19, 2012

(54) MANUFACTURING METHOD OF ELECTRODE OF POWER STORAGE DEVICE, ELECTRODE OF POWER STORAGE DEVICE, AND POWER STORAGE DEVICE

(75) Inventors: Mako Kishino, Hadano (JP); Mayumi Mikami, Atsugi (JP); Konami Izumi, Kyoto-shi (JP)

(73) Assignee: Semiconductor Energy Laboratory Co., Ltd.

(21) Appl. No.: 13/181,592

(22) Filed: Jul. 13, 2011

(30) Foreign Application Priority Data
Jul. 15, 2010 (JP) 2010-160951

(51) Int. Cl. H01M 4/66; H01M 4/139; B05D 5/12; B82Y 40/00; B82Y 30/00

(52) U.S. Cl. 429/215; 429/217; 427/122; 427/126.1; 427/58; 977/734; 977/842; 977/890; 977/948

(57) ABSTRACT

A shiny is manufactured using a low-molecular-weight organic acid as a dispersant and a nonaqueous organic solvent as a solvent, whereby a coated electrode for a power storage device in which an active material which has been made into microparticles each having a particle diameter of 100 nm or less is uniformly dispersed can be manufactured. By the use of the coated electrode manufactured in this manner, a power storage device with high charge/discharge characteristics can be manufactured. In other words, a power storage device with high capacity density can be realized because the amount of impurities is small and the power density is high due to the sufficient dispersion of the active material in the active material layer.

### BACKGROUND OF THE INVENTION

1. Field of the Invention

The present invention relates to an electrode of a power storage device, a manufacturing method of the electrode, and a power storage device including the electrode.

2. Description of the Related Art

An electrode of a power storage device such as a lithium-ion secondary battery, an electric double-layer capacitor, or a lithium-ion capacitor is formed in such a manner that a current collector, which is a metal foil formed by thinning a metal, is coated with a slurry formed by mixing an electrode active material, a conductive auxiliary agent, and the like (this electrode is generally referred to as “a coated electrode”). Such battery and capacitor basically have a similar structure, and can be manufactured by a combination of an active material to be mixed when a slurry is manufactured and an electrolytic solution to be used when a power storage device is assembled.

An important subject for enhancing the characteristics of a power storage device is uniform dispersion of a conductive auxiliary agent and an electrode active material serving as a material for a coated electrode in a slurry. To achieve this subject, for example, a method is given in which a mixture is dispersed by adding ultrasonic vibration in the middle of manufacturing a slurry as shown in Patent Document 1.

There is another method in which a dispersant is mixed into a slurry in order to disperse an active material and a conductive auxiliary agent while the aggregation thereof is suppressed. As the dispersant, a surface-active agent is generally given. In another method, an organic acetic acid having an amino group or an imino group is mixed into a slurry as shown in Patent Document 2.

### REFERENCES

### [Patent Document 1] Japanese Published Patent Application No. 2009-032427

### [Patent Document 2] Japanese Published Patent Application No. 2006-309958

### SUMMARY OF THE INVENTION

In recent years, the size of an active material (particle diameter) has been likely to decrease to several hundreds of nanometers or less in order to maximize the performance of the active material. Researches have been advanced on active materials which can deliver their performance by the decrease in particle diameter to several hundreds of nanometers or less. A microparticle with a particle diameter of several hundreds of nanometers or less has a large surface area in comparison to its volume; therefore, such microparticles are very likely to aggregate and easy dispersion of the microparticles is difficult with conventional techniques.

For example, just addition of ultrasonic vibration would hardly disperse an active material with a particle diameter of 100 nm or less.

Further, a dispersant prevents the aggregation of particles basically by adsorption of the dispersant on a particle surface to provide a steric barrier. However, it is known that when the particle diameter of the particle is too small, the function as the dispersant decreases due to various reasons depending on the material of the particle; for example, favorable adsorption is hindered, a steric barrier group does not function sufficiently, or an adsorption capability is too high.

In the case of mixing a surface-active agent or an acetic acid with a high molecular weight having an amino group or an imino group as shown in Patent Document 2, even though the function as the dispersant is not decreased, the capacity of a battery per unit weight and the capacity of a battery per unit volume are decreased because the dispersant remains in the electrode as an impurity having large weight.

Consequently, it is an object of the present invention to provide a manufacturing method of a coated electrode with no large impurities left even after the manufacture of the electrode and with uniform dispersion of an active material even when the active material is a microparticle with a particle diameter of several hundreds of nanometers or less. In other words, it is an object of the present invention to provide a manufacturing method of a coated electrode by which microparticles as the active material are dispersed uniformly, the characteristics are maximized, and the impurities are decreased, so that the capacity of a battery of the electrode as a whole can be increased.

Further, it is an object of the present invention to provide an electrode of a power storage device manufactured by the manufacturing method of the coated electrode, and a power storage device with enhanced characteristics by the use of the coated electrode.

One embodiment of the present invention relates to a coated electrode manufactured using an active material with small particle diameter; specifically, one embodiment of the present invention is applicable in the case of using an active material with a particle diameter of 100 nm or less. In the case of manufacturing a coated electrode using such an active material, a slurry is formed by dispersing the active material, a conductive auxiliary agent, a binder, and a low-molecular-weight organic acid, specifically an organic acid with a molecular weight of 193 or less in a nonaqueous solvent. Then, a surface of a current collector is thinly coated with the slurry, which is a metal foil, and the slurry with which the surface is coated is heated so that the nonaqueous solvent is vaporized, whereby a coated electrode is manufactured.

The active material particles can be charged by putting the organic acid in the slurry in which the nonaqueous solvent and the active material with small particle diameter are mixed. When the active material has a particle diameter as small as 100 nm or less, a low-molecular-weight organic acid with small molecular weight can be employed as the dispersant because the particles rebound against each other due to the rebound force of a charge on a surface of the active material particle so that the aggregation can be suppressed.

An inorganic acid can be taken into consideration as the low-molecular-weight acid; however, since an inorganic acid is a strong acid, there is a risk that the material of the coated electrode such as a binder might be changed irreversibly. Therefore, an organic acid, which is a weaker acid than an inorganic acid, is used.

Further, the coated electrode manufactured by the above method is also one embodiment of the present invention, and a power storage device including the coated electrode is also one embodiment of the present invention.

According to one embodiment of the present invention, a low-molecular-weight organic acid is used as a dispersant and a slurry is manufactured using a nonaqueous organic solvent as a solvent, whereby an active material which has been made into particles each having a particle diameter of 100 nm or less can be dispersed uniformly and the performance of the active material can be maximized. Furthermore, since the molecular weight of the impurity included in the coated electrode can be decreased, the capacity of a battery per unit weight or the capacity of a battery per unit volume can be increased.

Further, according to one embodiment of the present invention, a coated electrode with favorable characteristics manufactured by the manufacturing method of the coated electrode can be provided and moreover, a power storage device with enhanced characteristics by the use of the coated electrode can be provided.

### BRIEF DESCRIPTION OF THE DRAWING

FIG. 1 shows an example of a cross-sectional view of a power storage device.

### DETAILED DESCRIPTION OF THE INVENTION

Embodiments and Example of the present invention are described below. Note that it is easily understood by those skilled in the art that Embodiments and Example below can be carried out in a variety of different modes. Therefore, the present invention is not construed as being limited to the description of the following Embodiments and Example only.

### Embodiment 1

Embodiment 1 will describe a manufacturing method of a coated electrode of a power storage device.

First, a slurry is manufactured by dispersing an active material with a particle diameter of 100 nm or less, a conductive auxiliary agent, a binder, and a low-molecular-weight organic acid in a nonaqueous solvent. Then, a surface (one surface or opposite surfaces) of a current collector is coated with the slurry, which is a metal foil. Lastly, heat is added so as to vaporize the nonaqueous solvent in the slurry coating the surface of the current collector.

Specifically, in the case of manufacturing a positive electrode of a lithium-ion secondary battery, lithium iron phosphate is given as an example of the active material. In the case of manufacturing a negative electrode of a lithium-ion secondary battery or a lithium-ion capacitor, carbon is given as an example of the active material; in the case of manufacturing a positive electrode of a lithium-ion capacitor or an electrode of an electric double-layer capacitor, activated carbon is given as an example of the active material.

As the conductive auxiliary agent, acetylene black or Ketjen black is given; as the binder, PTFE (polytetrafluoroethylene) or PVDF (polyvinylidene fluoride) can be used.

As an example of the nonaqueous solvent, NMP (N-methyl-2-pyrrolidone) is given.

Further, as the current collector, an aluminum foil or a copper foil may be used. The current collector is not limited to the metal foil, and a punched metal or an expanded metal provided with an opening may be used. For stirring and mixing the slurry, a ball mill, a planetary centrifugal mixer, a homogenizer, or the like can be used. For vaporizing the solvent in the slurry coating the surface of the current collector, a vacuum drier, an infrared oven, a forced-air drier, or the like can be used.

As the low-molecular-weight organic acid, materials having a molecular weight of 193 or less such as a formic acid, an acetic acid, an oxalic acid, a citric acid (molecular weight: 192.13), and the like are given. Among the above low-molecular-weight organic acids, a citric acid has the highest molecular weight.

It is considered that these organic acids function as the dispersant in accordance with the following principle: ions separated from the organic acid are adsorbed on the particle surface of the active material which has been made into microparticles and the microparticles rebound against each other due to the rebound force by the charge so that the aggregation is suppressed. The rebound force by the charge of the adsorbed ion can be utilized in this manner because the active material has been made into microparticles so that the surface area thereof is large with respect to the volume (weight) of the particle. The charge of the ion adsorbed on the particle surface of the active material can become a force of making the particles with light weight rebound against each other. That is to say, the active material with a particle diameter of 100 nm or less is used, the ion separated from the organic acid is adsorbed on the particle surface of the active material, and the microparticles rebound against each other due to the rebound force by the charge, so that the active material is dispersed uniformly.

On the other hand, in the case where the active material particle is large, it is difficult to disperse the active material particles just by the rebound force by the charge of the ion, and it is necessary to use a dispersant with a high molecular weight for the dispersion. For example, in the case of mixing an organic acid with a high molecular weight as the dispersant, an ion with a large side chain separated from the organic acid is adsorbed on the particle surface and the active material is dispersed by utilizing the large side chain working as a steric barrier group between the active material particles. In the case of using a surface-active agent as the dispersant, similarly, the active material is dispersed by using a surface-active agent having the steric barrier group.

By the use of the organic acid with small molecular weight as the dispersant in order to disperse the active material which has been made into microparticles each having a particle diameter of 100 nm or less, the weight and volume of the dispersant in the electrode can be made drastically smaller than those in the case of using a dispersant with high molecular weight.

Accordingly, by the use of the low-molecular-weight organic acid as the dispersant, the amount of the active material per unit weight (or per unit volume) in the electrode is increased, so that the capacity of a battery can be increased. In other words, as compared with the case of using the dispersant with high molecular weight, the impurity can be reduced by the amount thereof included in the side chain working as the steric barrier group.

Embodiment 1 can be combined with another Embodiment as appropriate.

### Embodiment 2

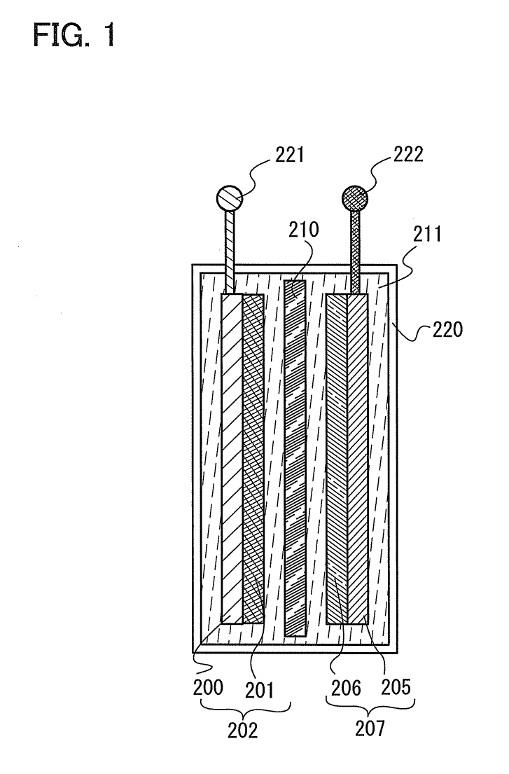

Embodiment 2 will describe an example of a manufacturing method of a power storage device. FIG. 1 schematically shows a lithium-ion secondary battery.

In the lithium-ion secondary battery illustrated in FIG. 1, a positive electrode 202, a negative electrode 207, and a separator 210 are provided in a housing 220 which is isolated from the outside, and the housing 220 is filled with an electrolyte solution 211. In addition, the separator 210 is provided between the positive electrode 202 and the negative electrode 207.

In the positive electrode 202, a positive electrode active material layer 201 is formed in contact with a positive electrode current collector 200. The positive electrode active material layer 201 can be manufactured in such a manner that the positive electrode current collector 200 is coated with a slurry formed by dispersing an active material (such as lithium iron phosphate) with a particle diameter of 100 nm or less, a conductive auxiliary agent, a binder, and a low-molecular-weight organic acid in a nonaqueous solvent as described in Embodiment 1. In this specification, the positive electrode active material layer 201 and the positive electrode current collector 200 provided therewith are collectively referred to as the positive electrode 202.

On the other hand, in the negative electrode 207, a negative electrode active material layer 206 is formed in contact with a negative electrode current collector 205. In this specification, the negative electrode active material layer 206 and the negative electrode current collector 205 provided therewith are collectively referred to as the negative electrode 207.

The negative electrode active material layer 206 can be manufactured in such a manner that the negative electrode current collector 205 is coated with a slurry formed by dispersing an active material (such as carbon) with a particle diameter of 100 nm or less, a conductive auxiliary agent, a binder, and a low-molecular-weight organic acid in a nonaqueous solvent as described in Embodiment 1.

A first electrode 221 and a second electrode 222 are connected to the positive electrode current collector 200 and the negative electrode current collector 205, respectively, and charge and discharge are performed by the first electrode 221 and the second electrode 222.

Moreover, in FIG. 1, there are certain gaps between the positive electrode active material layer 201 and the separator 210 and between the negative electrode active material layer 206 and the separator 210. However, the structure is not particularly limited thereto; the positive electrode active material layer 201 may be in contact with the separator 210, and the negative electrode active material layer 206 may be in contact with the separator 210. Further, the whole battery may be rolled into a cylinder shape with the separator 210 interposed between the positive electrode 202 and the negative electrode 207.

As the separator 210, paper, nonwoven fabric, a glass fiber, a synthetic fiber such as nylon (polyamide), vinylon (also called vinalon) (a polyvinyl alcohol based fiber), polyester, acrylic, polyolefin, or polyurethane, or the like may be used. Note that a material which does not dissolve in the electrolyte solution 211 should be selected.

In this manner, by the use of the coated electrode manufactured by the method disclosed in Embodiment 1, a power storage device with high charge/discharge characteristics can be manufactured. In other words, a power storage device with high capacity density can be realized because the amount of impurities is small and the power density is high due to the sufficient dispersion of the active material in the active material layer.

When charge of the lithium-ion secondary battery described above is performed, a positive electrode terminal is connected to the first electrode 221 and a negative electrode terminal is connected to the second electrode 222. An electron is taken away from the positive electrode 202 through the first electrode 221 and transferred to the negative electrode 207 through the second electrode 222. In addition, a lithium ion is eluted from the positive electrode active material in the positive electrode active material layer 201 from the positive electrode 202, reaches the negative electrode 207 through the separator 210, and is taken in the negative electrode active material in the negative electrode active material layer 206. The lithium ion and the electron are combined in this region and are occluded in the negative electrode active material layer 206. At the same time, in the positive electrode active material layer 201, an electron is released from the positive electrode active material, and an oxidation reaction of a transition metal (such as iron) contained in the positive electrode active material occurs.

At the time of discharge, in the negative electrode 207, the negative electrode active material layer 206 releases lithium as an ion, and an electron is transferred to the second electrode 222. The lithium ion passes through the separator 210, reaches the positive electrode active material layer 201, and is taken in the positive electrode active material in the positive electrode active material layer 201. At that time, an electron from the negative electrode 207 also reaches the positive electrode 202, and a reduction reaction of the transition metal (such as iron) contained in the positive electrode active material occurs.

Embodiment 2 can be freely combined with Embodiment 1.

### Example 1

Example 1 will describe a specific manufacturing method of a coated electrode.

First, an active material with small particle diameter and a dispersant are put into a solution in which a binder is dissolved in a nonaqueous solvent, and then the solution is stirred sufficiently. PVDF (polyvinylidene fluoride) is used as the binder, NMP (N-methyl-2-pyrrolidone) is used as the nonaqueous solvent, lithium iron phosphate with a particle diameter of approximately 20 nm is used as the active material, and an acetic acid (molecular weight: 60.05) is used as the dispersant. At the time of mixing them, the amount of the nonaqueous solvent to be added is preferably reduced. For the stirring, a homogenizer is used, and the mixing is performed for 15 minutes or more at 2000 rpm; thus, a slurry is obtained.

Secondly, a conductive auxiliary agent is added to the slurry and it is further stirred. Acetylene black is used as the conductive auxiliary agent. After the addition of the conductive auxiliary agent, the stirring is performed for 20 minutes or more at 2000 rpm again so that a thick paste is obtained.

Thirdly, the nonaqueous solvent is added again to decrease the viscosity of the slurry to a desired level. Then, the stirring is performed for approximately 15 minutes at 2000 rpm and a slurry for forming a coated electrode is obtained.

Fourthly, a current collector is coated with the obtained slurry. An aluminum foil is used as the current collector, and a film applicator (or also referred to as a doctor blade) or a screen printing method is used for the coating.

Lastly, the slurry with which the surface is coated is heated so that the nonaqueous solvent is vaporized. In order to vaporize the solvent, the heating is performed for an hour or more using a vacuum drier with a degree of vacuum of 1×10⁻³ Pa or less at a temperature kept at 110° C. or more. Through the aforementioned manufacturing process, the coated electrode can be manufactured.

The aforementioned process may be performed in the atmosphere; however, it is preferably performed in a dry room or a glove box in which the humidity can be controlled. This is to prevent the mixture of impurities such as moisture to the inside of the power storage device in the case of manufacturing the power storage device with the use of the coated electrode manufactured through the above manufacturing process. The mixture of just a small amount of moisture, for example, moisture adsorbed on a surface of the coated electrode, leads to large deterioration of the power storage device.

Example 1 can be implemented in combination with Embodiment 1 or 2 as appropriate.

This application is based on Japanese Patent Application serial no. 2010-160951 filed with Japan Patent Office on Jul. 15, 2010, the entire contents of which are hereby incorporated by reference.

What is claimed is:

1. A manufacturing method of an electrode of a power storage device, comprising:
manufacturing a slurry by dispersing an active material with a particle diameter of 100 nm or less, a conductive auxiliary agent, a binder, and an organic acid with a molecular weight of 193 or less in a nonaqueous solvent;
coating a current collector with the slurry; and
heating the slurry with which the current collector is coated so that the nonaqueous solvent is vaporized,
wherein the current collector is a metal foil.

2. The manufacturing method of an electrode of a power storage device according to claim 1,
wherein the active material is a material selected from the group consisting of lithium iron phosphate, carbon, and activated carbon.

3. The manufacturing method of an electrode of a power storage device according to claim 1,
wherein the conductive auxiliary agent is one of acetylene black and Ketjen black.

4. The manufacturing method of an electrode of a power storage device according to claim 1,
wherein the binder is one of polytetrafluoroethylene and polyvinylidene fluoride.

5. The manufacturing method of an electrode of a power storage device according to claim 1,
wherein the organic acid is an acid selected from the group consisting of a formic acid, an acetic acid, an oxalic acid, and a citric acid.

6. The manufacturing method of an electrode of a power storage device according to claim 1,
wherein the nonaqueous solvent is N-methyl-2-pyrrolidone.

7. The manufacturing method of an electrode of a power storage device according to claim 1,
wherein the current collector is one of an aluminum foil, a copper foil, a punched metal with an opening, and an expanded metal with an opening.

8. An electrode of a power storage device, comprising:
a current collector;
an active material with a particle diameter of 100 nm or less;
a conductive auxiliary agent;
a binder; and
an organic acid with a molecular weight of 193 or less,
wherein the active material, the conductive auxiliary agent, the binder, and the organic acid are provided on a surface of the current collector, and
wherein the current collector is a metal foil.

9. The electrode of a power storage device according to claim 8, wherein the active material is a material selected from the group consisting of lithium iron phosphate, carbon, and activated carbon.

10. The electrode of a power storage device according to claim 8,
wherein the conductive auxiliary agent is one of acetylene black and Ketjen black.

11. The electrode of a power storage device according to claim 8,
wherein the binder is one of polytetrafluoroethylene and polyvinylidene fluoride.

12. The electrode of a power storage device according to claim 8,
wherein the organic acid is an acid selected from the group consisting of a formic acid, an acetic acid, an oxalic acid, and a citric acid.

13. The electrode of a power storage device according to claim 8,
wherein the current collector is one of an aluminum foil, a copper foil, a punched metal with an opening, and an expanded metal provided with an opening.

14. A power storage device comprising an electrode, the electrode comprising:
a current collector;
an active material with a particle diameter of 100 nm or less;
a conductive auxiliary agent;
a binder; and
an organic acid with a molecular weight of 193 or less,
wherein the active material, the conductive auxiliary agent, the binder, and the organic acid are provided on a surface of the current collector, and
wherein the current collector is a metal foil.

15. The power storage device according to claim 14,
wherein the active material is a material selected from the group consisting of lithium iron phosphate, carbon, and activated carbon.

16. The power storage device according to claim 14,
wherein the conductive auxiliary agent is one of acetylene black and Ketjen black.

17. The power storage device according to claim 14,
wherein the binder is one of polytetrafluoroethylene and polyvinylidene fluoride.

18. The power storage device according to claim 14,
wherein the organic acid is an acid selected from the group consisting of a formic acid, an acetic acid, an oxalic acid, and a citric acid.

19. The power storage device according to claim 14,
wherein the current collector is one of an aluminum foil, a copper foil, a punched metal with an opening, and an expanded metal provided with an opening.
